(19) United States
(12) Patent Application Publication
(10) Pub. No.: US 2009/0327000 A1
(43) Pub. Date: Dec. 31, 2009

(54) Managing Change Requests in an Enterprise

(76) Inventors: Trevor A. Davis, Luton (GB); Vincent B. Marcellino, Howard, OH (US); Kevin C. McIntosh, Cleveland, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/164,623

(22) Filed: Jun. 30, 2008

(51) Int. Cl. G06Q 10/00

(52) U.S. Cl. 705/7

(57) ABSTRACT

Systems, methods, and apparatus, including software tangibly stored on a computer readable medium, involve managing change requests in an enterprise. Multiple factors for assessing risk associated with implementing changes within an enterprise are defined, and multiple risk assessment characteristics are associated with each factor. An identification of one of the risk assessment characteristics for each of the factors is received through a user interface. The received identification of risk assessment characteristics is associated with a particular request for approval of a change within the enterprise. A maximum overall risk assessment level for the particular request is identified based on the received identification of risk assessment characteristics for each of a first subset of the factors. An overall risk assessment level is determined for the particular request based, at least in part, on the maximum overall risk assessment level.

### BACKGROUND

This description relates to managing change requests, and in particular, to managing change requests in an enterprise.

An enterprise, such as a business, an organization, or an individual, may be exposed to risk as a result of enterprise operations. For example, there may be some unknown or uncertain costs associated with a particular aspect of enterprise operations. An enterprise's assessment of risk can be useful in making decisions related to future or current activities of the enterprise. For example, the enterprise may consider how implementing a particular change would impact the enterprise as a whole.

Traditional assessment of risk may include evaluating risk associated with implementing a particular change based on attributes of the particular change. For example, traditional methodology may include identifying the attributes of a change for multiple attribute categories. Based on the identified attributes for all of the attribute categories, the severity of risk associated with implementing the particular change is determined and evaluated.

### SUMMARY

In one general aspect, multiple factors for assessing risk associated with implementing changes within an enterprise are defined, and multiple risk assessment characteristics are associated with each factor. An identification of one of the risk assessment characteristics for each of the factors is received through a user interface. The received identification of risk assessment characteristics is associated with a particular request for approval of a change within the enterprise. A maximum overall risk assessment level for the particular request is identified based on the received identification of risk assessment characteristics for each of a first subset of the factors. An overall risk assessment level is determined for the particular request based, at least in part, on the maximum overall risk assessment level.

Implementations can include one or more of the following features. The risk assessment characteristics can be risk weighting values. The risk associated with implementing changes within the enterprise includes a potential impact on financial profit, business continuity, reputation of the enterprise, technology infrastructure availability, and/or technology infrastructure operability. The particular request relates to a change to an information technology infrastructure and/or a business process within the enterprise. The factors include factors related to resources of the enterprise associated with implementing the change, an environment associated with the change, and/or an uncertain outcome associated with implementing the change. The factors include factors related to an environment affected by the change, a fault tolerance of systems affected by the change, scheduling of the change, a number of personnel involved in implementing the change, an amount of experience of the personnel involved in implementing the change, an amount of testing conducted before implementing the change, an amount of testing conducted after implementing the change, a complexity of abandoning the change, an amount of time available for implementing the change, a measure of stability of an environment associated with the change, accuracy of a knowledge base for implementing the change, and/or completeness of the knowledge base for implementing the change.

The risk assessment characteristics define properties of possible changes in the enterprise, and each risk assessment characteristic is associated with a numerical value indicating a severity of risk associated with implementing changes having the property defined by the risk assessment characteristic. The overall risk assessment level is further based on the received identification of risk assessment characteristics for a second subset of the factors. The second subset of factors includes at least one of the factors included in the first subset of factors. The first subset of factors includes a factor relating to a type of environment associated with the change. The first-subset of factors includes a factor relating to a redundancy of systems affected by the change. The particular request for approval of the change is transmitted. The particular request is approved or denied based at least in part on the determined overall risk assessment level. The overall risk assessment level is based in part on a combination of the risk weighting values identified for a second subset of the factors. The overall risk assessment level is determined based solely on the first subset of factors. A change assessment interface is presented to a user. The change assessment interface includes a characteristic identification module for a user to identify one of the risk weighting values for the each of the factors. The characteristic identification module includes at least one drop-down menu. A user interface is adapted to receive data included in the requests for approval. A graphical user interface is adapted to display risk assessment data to a user. The described techniques can be implemented in methods, systems, apparatus, computer program products, or otherwise, tangibly stored on a computer readable medium as instructions operable to cause programmable processor to perform actions.

The details of one or more implementations are set forth in the accompanying drawings and the description below. Other features will be apparent from the description and drawings, and from the claims.

### DESCRIPTION OF DRAWINGS

FIG. 1 is a block diagram illustrating an example system for managing change requests in an enterprise.

FIG. 2 is a block diagram illustrating an example interface for entering risk assessment factors.

FIG. 3 is a flow chart illustrating an example process for managing a change request in an enterprise.

FIG. 4 is a flow chart illustrating an example process for managing a change request in an enterprise.

Like reference symbols in the various drawings indicate like elements.

### DETAILED DESCRIPTION

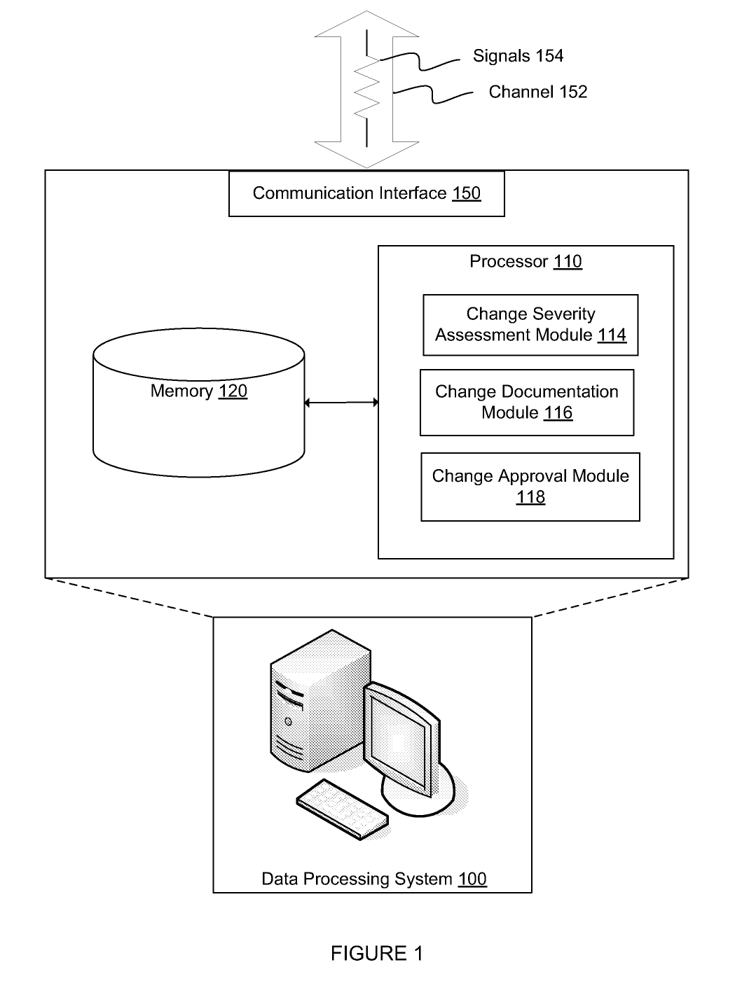

FIG. 1 is a block diagram illustrating an example data processing system 100 for managing change requests in an enterprise. The example system 100 can evaluate risk associated with implementing a particular change in the enterprise based at least in part on a maximum overall risk level associated with the particular change. The system 100 determines the maximum overall risk level based on a subset of risk assessment characteristics of the particular change. For example, in some cases the system 100 determines the maximum overall risk level for a particular change based on a single risk assessment characteristic. In some implementations, the system 100 improves efficiency of change management by reducing the amount of human and/or computational resources involved in the evaluation of risk associated with changes.

A request for approval of a particular change can be transmitted along with identification of the overall risk level. In some cases, a decision regarding implementation of the particular change is based at least in part on the determined overall risk level. For example, the enterprise may limit or prohibit the implementation of changes associated with a high risk level, without limiting changes associated with a low risk level. As another example, the overall risk level determined by the system 100 may be used to identify a level of enterprise management authorized to approve the change.

In some implementations, the system 100 evaluates the severity of potential effects that a particular change may have on the enterprise. For example, the system 100 may evaluate risk related to financial profits, business continuity, information technology infrastructure, reputation of the enterprise, and/or other factors. In some implementations, a particular change can include a change to an enterprise system, procedure, personnel, policy, and/or others. For example, a particular change may include updating a network server, updating a computer software version, delaying or advancing a deadline for a project or a project start date, replacing an IT infrastructure component (e.g., a server, a printer, a router, a workstation, or others), changing a mode of transportation of supplies, changing a route of transportation of supplies, changing a supplier of a particular good or service, changing a communication interface, changing a physical location of an asset, trading a financial instrument, and/or others.

The data processing system 100 includes a central processor 110, which executes programs, performs data manipulations, and controls tasks in the system 100. The processor 110 includes a change severity assessment module 114, a change documentation module 116, and a change approval module 118, which can be implemented as hardware or software. The processor 110 is coupled with a memory 120, for example, through a bus that can include multiple busses, which may be parallel and/or serial busses. The memory 120 can be volatile and/or non-volatile memory, and is coupled with a communication interface 150, for example, through a communications bus. The memory 120 stores data related to change records, risk factors, risk assessment characteristics, in addition to other information related to managing change requests. The system 100 can also include one or more cache memories and/or a storage device. The storage device may be used for accessing a storage medium, such as removable, read-only, or read/write media. Storage media may be magnetic-based, optical-based, semiconductor-based media, or a combination of these. The system 100 can also include one or more peripheral devices, and one or more controllers and/or adapters for providing interface functions. Example peripheral devices include a keyboard, a monitor, a mouse, a speaker, a microphone, and others. In some cases, interface for the system 100 is provided remotely over a network connection, in addition to, or rather than, locally.

The system 100 can further include a communication interface 150, which allows software and data to be transferred, in the form of signals 154 over a channel 152, between the system 100 and external devices, networks, or information sources. The signals 154 can embody instructions for causing the system 100 to perform operations. The system 100 represents a programmable machine, and can include various devices such as embedded controllers, Programmable Logic Devices (PLDs), Application Specific Integrated Circuits (ASICs), and the like. Machine instructions (also known as programs, software, software applications or code) can be stored in the machine 100 and/or delivered to the machine 100 over a communication interface. These instructions, when executed, enable the machine 100 to perform the features and functions described herein. These instructions represent controllers of the machine 100 and can be implemented in a high-level procedural and/or object-oriented programming language, and/or in assembly/machine language. Such languages can be compiled and/or interpreted languages.

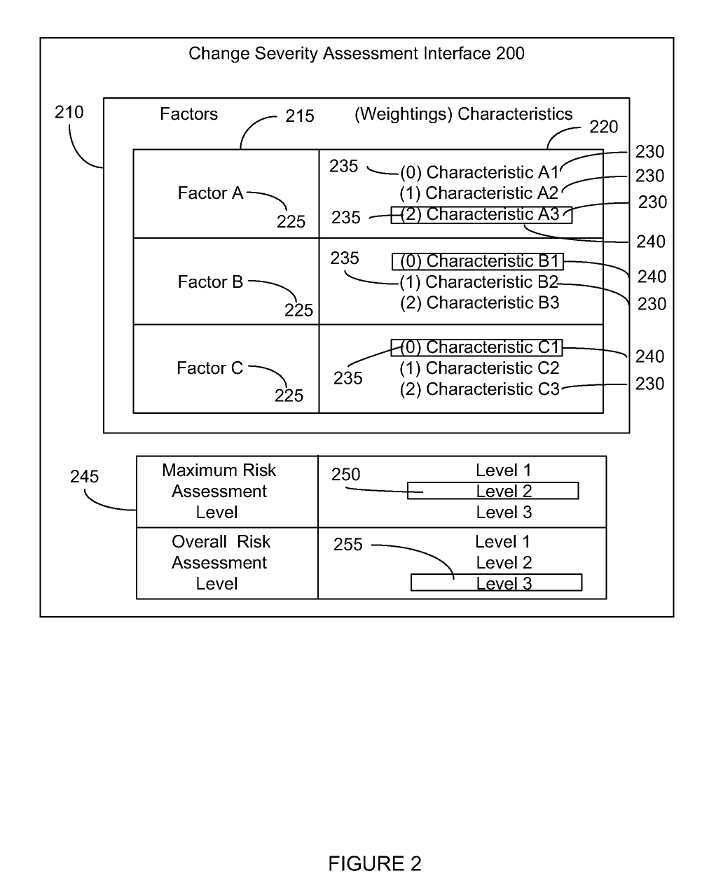

The change severity assessment module 114 determines an overall level of risk associated with implementing a particular change in an enterprise based, at least in part, on a maximum overall risk level associated with implementing the particular change. The change severity assessment module 114 determines the maximum overall risk level associated with implementing the change based on risk assessment characteristics associated with a subset of risk factors. For example, the risk factors may include factors related to resources of the enterprise associated with implementing the change, an environment associated with implementing the change, an uncertain outcome associated with implementing the change, and/or others. More specific examples of risk factors are discussed in more detail below, with respect to FIG. 2. In some implementations, the change severity assessment module 114 determines a maximum overall risk level associated with a particular change based on the environment where the particular change will be implemented. In other implementations, the change severity assessment module 114 determines a maximum overall risk level associated with a particular change based on the environment where the particular change will be implemented in addition to the redundancy of systems associated with implementing the particular change.

Multiple risk assessment characteristics are associated with each risk factor. In some implementations, a different subset of the risk assessment characteristics is associated with each factor. A given risk factor may identify a category of possible change attributes, and each risk assessment characteristic associated with the given risk factor may identify a possible change attribute in the category. One example risk factor is whether pre-implementation testing has been conducted, and the risk assessment characteristics associated with pre-implementation testing can indicate that the change is fully tested, the change has not been tested, the change has been partially tested, and/or others. Another example risk factor relates to configuration documentation maturity, and the risk assessment characteristics associated with configuration documentation maturity can indicate that documentation for implementing the change is accurate and/or complete, the documentation is partially accurate and/or complete, the documentation is incomplete and/or inaccurate, and/or others.

A weighting value can be associated with each risk assessment characteristic. In some implementations, a weighting value can be a numerical value indicating a risk level associated with a change having the risk assessment characteristic. For example, risk assessment characteristics associated with a higher level of risk may have a higher weighting factor. Alternatively, risk assessment characteristics associated with a higher level of risk may have a lower weighting factor. In some cases, the change severity assessment module 114 determines the overall risk level and/or the maximum overall risk level based on a subset of risk assessment characteristics by summing (or otherwise combining) the weighting values associated with the subset of risk assessment values. In some implementations, the weighting values are non-numerical values. For example, a risk weighting value can be a text string that qualitatively describes the risk assessment characteristic (e.g., “testing and development environment,” “production environment,” “critical production environment,” “full redundancy,” “partial redundancy,” “no redundancy,” or another value).

In some implementations, the weighting values are used instead of risk assessment characteristics. A weighting value may be used to directly indicate a risk level associated with a given risk factor. As an example, instead of using risk assessment characteristics to identify the type of environment where the change will be implemented (e.g., “testing environment,” production environment,” or another environment), a risk weighting value may identify a level of risk (e.g., “0,” “1,” “2,” or another value) associated with the type of environment where the change will be implemented. The identified level of risk can be used to determine an overall risk level and/or a maximum overall risk level for the change. In some implementations, the weighting values associated with different risk factors may themselves be given different levels of importance (or weights) when determining an overall risk level or maximum overall risk level. Alternatively, these different “weights” may be built into the weighting values themselves.

In some implementations, the change severity assessment module 114 presents an interface for assessing risk associated with implementing a change. For example, the interface may be presented as a graphical user interface on a monitor or another peripheral device for display to one or more users. An example interface is illustrated in FIG. 2. In some implementations, the interface includes a table for entering data, drop-down menus, sliders, and/or buttons for identifying risk assessment characteristics, and other interface features. The interface presents a risk factor and multiple associated risk assessment characteristics to the user. The interface allows the user to identify one of the risk assessment characteristics associated with the risk factor. In response to the user identifying a risk assessment characteristic, the interface presents one or more of a maximum overall risk assessment level for the change, an overall risk assessment level for the change, a risk weighting value for the identified characteristic, an additional risk factor and associated risk assessment characteristics, and/or other information.

In some implementations, the change severity assessment module 114 receives data entered by a project manager, a service technician, administrative personnel, an automated system, and/or another source. In some implementations, input and/or output data for the change severity assessment module 114 is stored in one or more change records. In some implementations, a change record is an electronic file including data related to a particular change. Change records can be stored in the memory 120, on a storage medium, or in a remote system. A change record can include detailed information about one or more particular changes. For example, a change record may identify a person or entity requesting the particular one or more changes, a person or entity implementing the particular one or more changes, a detailed description of the change or processes associated with the change, risk assessment characteristics associated with the particular one or more changes, the overall risk assessment level and/or the maximum overall risk assessment level for the particular one or more changes, an entity of the enterprise authorized to approve the particular one or more changes, and/or other information. A change record can be a useful resource for auditing changes and change approvals in the enterprise. For example, statistical data can be extracted from a volume of change records related to previously implemented changes. The statistical data may allow improved risk assessment of future change requests, for example, by identifying common characteristics among changes that lead to unexpected costs. As another example, the change record can be used to determine whether the characteristics identified for risk assessment purposes match the actual characteristics of the implemented change.

In an example implementation, a technician requests authorization to update a software version. The technician accesses the change severity assessment module 114, and the change severity assessment module 114 evaluates an overall risk level associated with updating the software version. The technician provides to the change severity assessment module 114 information identifying a risk assessment characteristic for each of one or more risk factors. Based on a subset of the identified characteristics, the risk assessment module 114 determines a maximum overall risk assessment level for updating the software version. Based on the maximum overall risk assessment level, the risk assessment module 114 determines an overall risk assessment level for updating the software version. In some cases, the overall risk assessment level for updating the software version may also be determined by the risk assessment module 114 based on a second subset of the identified characteristics.

The change documentation module 116 provides an auditable record for particular requested changes. For example, the change documentation module 116 may provide a change record. In some implementations, the change documentation module 116 creates a new change record based on information provided to the change documentation module 116. For example, a person or entity requesting approval of a particular change may provide information related to one or more characteristics of the particular change, and the change documentation module 116 may create a change record for the particular change. In some implementations, the change documentation module 116 provides information to the change severity assessment module 114. For example, the change documentation module 116 may provide an identification of risk assessment characteristics to the change severity assessment module 114. In some implementations, the change documentation module 116 receives information from the change severity assessment module 114. For example, the change documentation module 116 may receive an identification of an overall risk assessment level and/or a maximum overall risk assessment level from the change severity assessment module 114.

The change approval module 118 determines authorization to approve the change. The change approval module 118 can receive information related to a particular change from the change severity assessment module 114, the change documentation module 116, a user interface, and/or another source. For example, the change approval module 118 may receive a change record and/or an identification of an overall risk level for a particular change from the change severity assessment module 114 and/or the change documentation module 116. Based on the received information, the change approval module 118 identifies an entity or level of authorization for approving the particular change. For example, the change approval module 118 may identify that a management committee is authorized to approve a change based on the overall risk assessment level of the change and/or other information. In this example, implementation of the change is not allowed unless or until the management committee approves the change. As another example, the change approval module 118 may identify that a change approval board is authorized to approve a change based on the overall risk assessment level of the change and/or other information. As another example, the change approval module 118 may identify that no approval is needed in order to implement the change if the overall risk assessment level is below a threshold. In some implementations, the change approval module 118 determines authorization to approve a change request based on information other than or in addition to the overall risk assessment level of the change. For example, a change having a risk assessment level that would ordinarily require approval by management may be authorized without approval by management based on the urgency of the change. As another example, a change having a risk assessment level that would ordinarily not require approval by management may be designated for approval by management based on the person or entity requesting the change. The change approval module 118, in some implementations, additionally transmits a change request for approval and/or receives information identifying approval or denial of the change request. For example, the change approval module 118 may transmit a change record to the appropriate entity using the communication interface 150.

The illustrated system 100 is an example implementation of a system for managing change requests in an enterprise. Other implementations may include one or more variations. For example, in some implementations, some or all of the functionality described with respect to the change severity module 114, the change documentation module 116, and/or the change approval module 118 is implemented in a single module or on a plurality of different modules. In some implementations, the functionality of the modules 114, 116, and 118 are distributed over a plurality of processors and/or a plurality of workstations in a network. For example, the change severity assessment module 114 and the change documentation module 116 can be implemented on a first computer, while the change approval module 118 is implemented on a second, remote computer. In some implementations, the system 100 has no communication interface 150. In such an implementation, information can be uploaded and/or downloaded in the system 100, for example, using a storage device. In some implementations, the processor 110 includes multiple other modules that function along with the modules 114, 116, and 118 to evaluate risk associated with implementing changes in an enterprise.

FIG. 2 is a block diagram illustrating an example interface 200 for entering risk assessment factors. The example interface 200 presents in a risk assessment input table 210 multiple risk factors 225 in a first column 215 and multiple risk assessment characteristics 230 in a second column 220. The interface 200 also presents in the second column weighting values 235 associated with each risk assessment characteristic 230. The interface 200 allows one of the characteristics associated with each factor to be identified for a particular change (as indicated at 240). The interface 200 presents a risk assessment results table 245 that indicates a maximum overall risk assessment level 250 for the particular change as well as an overall risk assessment level 255 for the particular change. For example, the risk severity assessment module 114 may provide a maximum overall risk assessment level 250 and/or an overall risk assessment level 255 for the particular change, based on one or more of the characteristics 235 identified in the risk assessment input table 210. In some implementations, the interface 200 presents more or fewer than three risk factors 225 and/or more or fewer than three risk assessment characteristics 230 associated with one or more of the risk factors 225. In some implementations, the interface 200 presents the overall risk assessment level 255 without presenting the maximum overall risk assessment level 250. In some implementations, the interface 200 presents either the risk assessment characteristics 230 or the risk weighting values 235, but not both. In some implementations, the second column 220 in the risk assessment input table 210 presents blank cells for receiving manual entry of risk weighting values and/or risk assessment characteristics. In some implementations, the interface 200 is presented in a spreadsheet format, such as Microsoft Excel. In such implementations, the functionality associated with one or more of the modules 114, 116, and/or 118 can be implemented as formulas and/or macros defined in the spreadsheet.

The factors for assessing risk for changes in the enterprise can include factors related to resources of the enterprise associated with implementing the change, an environment associated with implementing the change, an uncertain outcome associated with implementing the change, and/or others. Examples of resources of the enterprise include time, personnel, capital, knowledge base, and/or others. Factors related to resources of the enterprise associated with implementing the change include scheduling of the change, a number of teams or groups involved with the change, the level of experience of the teams involved with the change, an implementation window, configuration documentation maturity, and/or others. Factors related to an environment associated with implementing the change include environments affected by the change, environments where the change will be implemented, stability of the environments, and/or others. Factors related to an uncertain outcome associated with implementing the change include fault tolerance of systems and/or processes associated with the change, pre-implementation testing of the change, post-implementation verification of the change, back-out plans, and/or others. In some implementations, factors related to other aspects of change implementation and/or risk assessment are included.

Examples of risk assessment characteristics associated with scheduling include: the change is scheduled within a maintenance window, the change is scheduled outside of a maintenance window, the change is scheduled during peak hours, the change is scheduled during off-peak or non-peak production time periods, the change is scheduled during freeze or non-freeze time periods, and/or others. A maintenance window may include a pre-scheduled and/or regularly-scheduled time period where enterprise systems are updated and/or changed.

Examples of different numbers of teams or groups involved with the change include one group involved with the change, two groups involved with the change, or any number of groups or teams involved with implementing the change.

Examples of different levels of experience of the teams involved with the change include common (i.e., the team is expert at the activity), familiar (i.e., the team is familiar with the activity), new (i.e., the team has never performed the activity), and/or others.

Examples of risk assessment characteristics associated with the implementation window factor include: adequate time to implement, verify, back out and/or deal with issues prior to client impact, moderate risk of exceeding window (e.g., resulting in client impact), insufficient time to implement, verify, back out and/or deal with issues prior to client impact, and/or others.

Examples of risk assessment characteristics associated with the configuration documentation maturity include: the documentation is accurate and/or complete, the documentation is partially accurate and/or complete, the documentation is incomplete and/or inaccurate, and/or others.

Examples of different environments where changes are implemented include a development and testing environment, a critical environment, a non-critical environment, a production environment, an environment where one or more clients are affected, an environment where no clients are affected, an environment where daily operations are affected, a public environment, a private environment, and/or others.

Examples of risk assessment characteristics associated with the stability of the environment relate to potential problem analysis, for example, if there is a problem resulting from implementing a change in the environment. For example, the environment may be considered stable and controlled, the environment may be considered to include some instability, and/or the environment may be considered to be unstable or obsolete.

Examples of risk assessment characteristics associated with the fault tolerance of systems and/or processes associated with the change include different levels of system redundancy. Examples of different levels of redundancy include full redundancy, single point of failure (i.e., no redundancy), different levels of partial redundancy, and/or others.

Examples of risk assessment characteristics associated with the pre-implementation testing of the change include: the change is fully tested, the change has not been tested, the change cannot be tested, the change is partially tested, and/or others.

Examples of risk assessment characteristics associated with the post-implementation verification of the change include: all client functionality to be verified within implementation window, client functionality not to be verified during implementation window, change cannot be verified until production load is on system, implementation teams will verify system, and/or others.

Examples of risk assessment characteristics associated with the back-out plans include easy (e.g., back-out plan is known and/or tested), moderate (e.g., back-out plan may exceed time window for back-out), difficult (e.g., complex, unproven, or mixed success), not feasible (e.g., change cannot be reversed, back-out requires restore or rebuild), and/or others.

In the illustrated example, each of the risk assessment characteristics 230 is associated with a weighting value of either 0, 1, or 2. However, in some cases, different and/or additional values are used. The maximum overall risk assessment value 250 indicated in the interface 200 is determined based on one or more characteristics indicated for a subset of the factors listed in the table 210. For example, the maximum overall risk assessment value 250 may be determined based only on an indication of Characteristic A3, or the maximum overall risk assessment value may be determined based on an indication of Characteristic A3 and Characteristic B1. The overall risk assessment value 255 indicated in the display 200 is determined based at least in part on the maximum overall risk assessment value 250. In some implementations, the overall risk assessment value 255 in the example is determined based, additionally on the indication of Characteristic C1, Characteristic A3, and/or Characteristic B1.

In some implementations, one of three, different overall risk assessment levels is determined for all changes. A first overall risk assessment level, Level 1, indicates a major risk. Implementation of changes presenting a major risk may require, for example, approval from a management committee. A second overall risk assessment level, Level 2, indicates a significant risk, which is less severe than a major risk. Implementation of changes presenting a significant risk may require, for example, approval from a change approval board. A third overall risk assessment level, Level 3, indicates a minor risk, which is less severe than a significant risk. Implementation of changes presenting a minor risk can be implemented, for example, without further approval.

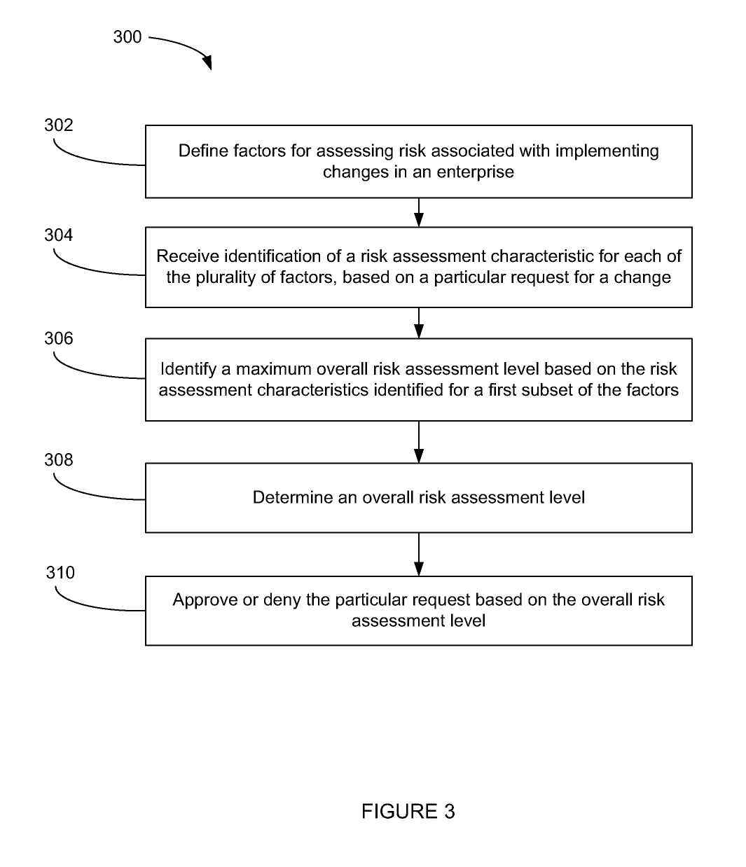

FIG. 3 is a flow chart illustrating an example process 300 for managing a change request in an enterprise. All or part of the example process 300 may be implemented by a computing device, for example, the system 100 of FIG. 1. In some implementations, the process 300 includes some, all, additional, different or fewer operations implemented in the same or a different order. In an example implementation, the process 300 provides information for identifying authorization needed to approve or deny a request for change and/or information for assessing uncertain costs associated with implementing the change. In some implementations, the risk associated with implementing changes within the enterprise includes a potential impact on at least one of financial profit, business continuity, reputation of the enterprise, technology infrastructure availability, technology infrastructure operability, and/or others.

At 302, factors for assessing risk associated with implementing changes in an enterprise are defined. In some implementations, one or more of the factors is related to at least one of resources of the enterprise associated with implementing the change, an environment associated with the change, or an uncertain outcome associated with implementing the change. In some implementations, the plurality of factors includes one or more factors discussed above with respect to FIGS. 1 and 2. For example, the factors can include an environment affected by the change, a fault tolerance of systems affected by the change, scheduling of the change, a number of personnel involved in implementing the change, an amount of experience of the personnel involved in implementing the change, an amount of testing conducted before implementing the change, an amount of testing conducted after implementing the change, a complexity of abandoning the change, an amount of time available for implementing the change, a measure of stability of an environment associated with the change, accuracy of a knowledge base for implementing the change, completeness of the knowledge base for implementing the change, and/or others.

In some implementations, multiple risk assessment characteristics are associated with each of the factors. In some implementations, the risk assessment characteristics define properties of possible changes in the enterprise, and each risk assessment characteristic is associated with a numerical value indicating a severity of risk associated with implementing changes having the property defined by the risk assessment characteristic. In some implementations, risk weighting values are used in place of or in addition to risk assessment characteristics.

At 304, an identification of a risk assessment characteristic for each of the plurality of factors is received. The identified risk assessment characteristics are based on a particular request for a change in the enterprise. In some implementations, the particular request relates to a change to an enterprise system, procedure, personnel, policy, and/or others. In some implementations, the particular request relates to at least one of a change to an information technology infrastructure or a business process within the enterprise. The risk assessment characteristic can be identified manually, automatically, or through a partially automated procedure.

At 306, a maximum overall risk assessment level is identified based on the risk assessment characteristics identified for a first subset of the factors. In some implementations, the maximum overall risk assessment level is identified based on risk weighting values associated with the risk assessment characteristics identified for the first subset of factors. In some implementations, the first subset of factors includes a factor relating to a type of environment associated with the change. For example, if the change is to be implemented in a testing and development environment, the maximum overall risk assessment level is ‘minor’ (Level 3). In this example, the lowest risk assessment level is Level 3. Therefore, if the maximum overall risk assessment level is Level 3, then the overall risk assessment level is also Level 3. Continuing the example, if the change is to be implemented in a non-key production environment, the maximum overall risk assessment level is ‘significant’ (Level 2), and if the change is to be implemented in a key production environment, the maximum overall risk assessment level is ‘major’ (Level 1). A key production environment can be identified by the enterprise or by a client of the enterprise. For example, a client may identify that web servers are a key production environment, while email is not a key production environment. Key production environments are typically more sensitive to change than non-key production environments.

In some implementations, the first subset of factors includes a factor relating to a redundancy of systems affected by the change. For example, redundancy of systems can include redundancy of processes, redundancy of software, redundancy of hardware, and/or others. In an example implementation, changes affecting fully redundant systems are associated with a lowest risk weighting value (e.g., zero), changes affecting partially redundant systems are associated with a medium risk weighting value (e.g., one), and changes affecting non-redundant systems (i.e., system that may have a single point of failure) are associated with a highest risk weighting value (e.g., two). In some implementations, the first subset of factors includes factors relating to redundancy of systems, an environment associated with the change, and/or another factor.

At 308, an overall risk assessment level is determined based on the maximum overall risk assessment level. In some implementations, the overall risk assessment level is further based on the received identification of risk assessment characteristics for a second subset of the plurality of factors. In some implementations, the maximum overall risk assessment level and/or the overall risk assessment level are determined based on a combination (e.g., summation, multiplication, or another) of risk weighting values associated with the identified risk assessment characteristics. For example, the risk weighting values associated with the risk assessment characteristics in the second and/or first subset may be summed and/or scaled to arrive at the overall risk assessment level. The overall risk assessment level may be included in a change record. The change record may be transmitted for approval. At 310, the particular request is approved or denied based on the overall risk assessment level.

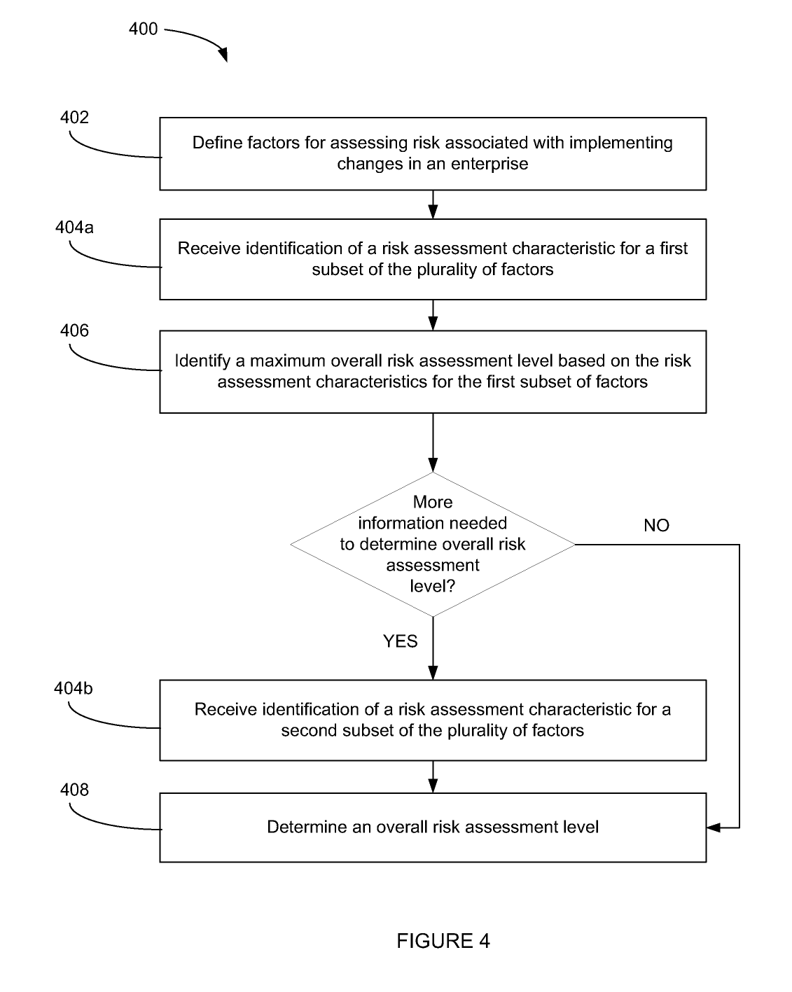

FIG. 4 is a flow chart illustrating an example process 400 for managing a change request in an enterprise. All or part of the example process 400 may be implemented by a computing device, for example, the system 100 of FIG. 1. In some implementations, the process 400 includes some, all, additional, different, or fewer operations implemented in the same or a different order. In an example implementation, the process 400 is implemented as a software tool on a computer workstation. A user of the workstation provides information to the software tool through an interface, and the software tool provides information to the user through a graphical user interface presented on a monitor.

At 402, factors for assessing risk associated with implementing changes in an enterprise are defined. At 404a, an identification of a risk assessment characteristic for each of a first subset of the plurality of factors is received. The identified risk assessment characteristics are based on a particular request for a change in the enterprise. At 406, a maximum overall risk assessment level is identified based on the first subset of risk assessment characteristics.

If sufficient information has been received to determine an overall risk assessment level, at 408, an overall risk assessment level is determined based at least in part on the maximum overall risk assessment level. Alternatively, if more information is needed in order to determine an overall risk assessment level, at 404b, an identification of risk assessment characteristics for a second subset of the factors is received. In some implementations, the second subset of factors includes at least one of the factors included in the first subset of factors which factors are included in the second subset of factors may be identified based on the identification of risk assessment characteristics for the first subset of factors, the identified maximum overall risk assessment level, information about the requested change, and/or other data. After the identification is received for the second subset, at 408, an overall risk assessment level is determined for the change based, at least in part, on the maximum overall risk assessment level and/or the risk assessment characteristics for the second subset of factors.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, the processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made. Accordingly, other implementations are within the scope of the following claims.

What is claimed is:

1. A method for managing change requests in an enterprise, the method comprising:
defining a plurality of factors for assessing risk associated with implementing changes within an enterprise, wherein a plurality of risk assessment characteristics is associated with each factor;
receiving, through a user interface, an identification of one of the plurality of risk assessment characteristics for each of the plurality of factors, wherein the received identification of risk assessment characteristics for the plurality of factors is associated with a particular request for approval of a change within the enterprise;
identifying a maximum overall risk assessment level for the particular request based on the received identification of risk assessment characteristics for each of a first subset of the plurality of factors; and
determining an overall risk assessment level for the particular request based, at least in part, on the maximum overall risk assessment level.

2. The method of claim 1, wherein the risk associated with implementing changes within the enterprise includes a potential impact on at least one of financial profit, business continuity, reputation of the enterprise, technology infrastructure availability, or technology infrastructure operability.

3. The method of claim 1, wherein the particular request relates to at least one of a change to an information technology infrastructure or a business process within the enterprise.

4. The method of claim 1, wherein the plurality of factors includes factors related to at least one of resources of the enterprise associated with implementing the change, an environment associated with the change, or an uncertain outcome associated with implementing the change.

5. The method of claim 1, wherein the plurality of factors includes at least one of an environment affected by the change, a fault tolerance of systems affected by the change, scheduling of the change, a number of personnel involved in implementing the change, an amount of experience of the personnel involved in implementing the change, an amount of testing conducted before implementing the change, an amount of testing conducted after implementing the change, a complexity of abandoning the change, an amount of time available for implementing the change, a measure of stability of an environment associated with the change, accuracy of a knowledge base for implementing the change, or completeness of the knowledge base for implementing the change.

6. The method of claim 1, wherein the risk assessment characteristics define properties of possible changes in the enterprise, and each risk assessment characteristic is associated with a numerical value indicating a severity of risk associated with implementing changes having the property defined by the risk assessment characteristic.

7. The method of claim 1, wherein the overall risk assessment level is further based on the received identification of risk assessment characteristics for a second subset of the plurality of factors.

8. The method of claim 7, wherein the second subset of factors comprises at least one of the factors included in the first subset of factors.

9. The method of claim 1, wherein the first subset of factors comprises a factor relating to a type of environment associated with the change.

10. The method of claim 1, wherein the first subset of factors comprises a factor relating to a redundancy of systems affected by the change.

11. The method of claim 1, further comprising transmitting the particular request for approval of the change.

12. The method of claim 1, further comprising at least one of approving or denying the particular request based at least in part on the determined overall risk assessment level.

13. A computer program product, tangibly stored on a computer-readable medium, comprising instructions operable to cause a programmable processor to:
define a plurality of factors for assessing risk associated with implementing changes within an enterprise, wherein a plurality of possible risk weighting values is associated with each factor;
receive, through a user interface, an identification of one of the plurality of risk weighting values for each of the plurality of factors, the received identification of risk weighting values for the plurality of factors associated with a particular request for approval of a change within the enterprise;
identify a maximum overall risk assessment level for the particular request based on the received identification of risk weighting characteristics for a first subset of the plurality of factors; and
determine an overall risk assessment level for the particular request based, at least in part, on the maximum overall risk assessment level.

14. The computer program product of claim 13, wherein the overall risk assessment level is based in part on a combination of the risk weighting values identified for a second subset of the plurality of factors.

15. The computer program product of claim 13, wherein the overall risk assessment level is determined based solely on the first subset of factors.

16. The computer program product of claim 13, further comprising instructions operable to cause the programmable processor to present a change assessment interface to a user, wherein the change assessment interface includes a characteristic identification module for a user to identify one of the plurality of risk weighting values for the each of the plurality of factors.

17. The computer program product of claim 16, wherein the characteristic identification module comprises at least one drop-down menu.

18. A system for managing change requests in an enterprise comprising:
a memory adapted to store requests for approval of changes in the enterprise, each request identifying one of a plurality risk assessment characteristics for each of a plurality of factors for assessing risk; and
a processor adapted to perform operations comprising:
determining a maximum overall risk assessment level for a particular request based on risk assessment characteristics identified for a first subset of the plurality of factors in the particular request; and
determining an overall risk assessment level for the particular request based, at least in part, on the maximum overall risk assessment level.

19. The system of claim 18, further comprising a user interface to receive data included in the requests for approval.

20. The system of claim 18, further comprising a graphical user interface to display risk assessment data to a user.
